(19) United States
(12) Patent Application Publication
(10) Pub. No.: US 2013/0208285 A1
(43) Pub. Date: Aug. 15, 2013

(54) METHOD AND DEVICE FOR MEASURING THE COLOUR AND OTHER PROPERTIES OF A SURFACE

(71) Applicants: Jari Miettinen, Vtt (FI); Heimo Keranen, Vtt (FI); Karri Niemela, Vtt (FI)

(72) Inventors: Jari Miettinen, Vtt (FI); Heimo Keranen, Vtt (FI); Karri Niemela, Vtt (FI)

(73) Assignee: TEKNOLOGIAN TUTKIMUSKESKUS VTT, Espoo (FI)

(21) Appl. No.: 13/809,164

(22) PCT Filed: Jul. 8, 2011
(86) PCT No.: PCT/FI11/50646

§ 371 Date: May 6, 2013

(30) Foreign Application Priority Data
Jul. 9, 2010 (FI) 20105783

(51) Int. Cl. G01N 21/27; G01B 11/30

(52) U.S. Cl. CPC G01N 21/274; G01B 11/30
USPC 356/600; 356/421; 356/448

(57) ABSTRACT

The invention relates to a device and method for measuring the properties of a surface. The device comprises means for producing illuminating light, which means are arranged to aim the illuminating light at the surface to be measured using at least two different wavelengths and at least two different angles, as well as means for directing the light reflected or scattered from the surface to a detector, in order to create an image of the surface to be measured. The device according to the invention further comprises at least one reference surface, the contents of which can be placed in the vicinity of the surface to be measured, in such a way that the illuminating light is also aimed at the reference surface and the light reflected or scattered from the reference surface can also be directed to the detector. The invention makes possible excellent measurement precision and repeatability, using a simple device construction with low production costs.

The invention relates to a method and device for measuring the colour and other properties of a surface, according to the preambles to the Claims.

Determining the visual appearance of surfaces requires several different types of measurement including colour and texture (spectral variable), degree of glossiness and scattering), as well as shape of the surface (micro-structure and topography). The colour of a surface is typically measured as points using a reflection spectrophotometer and the other properties of the surface are measured using separate glossiness, roughness, and scattering meters developed for them.

The present invention is intended to create a solution, by means of which surfaces can be studied more simply and economically.

The invention is based on the idea of using light to illuminate the surface to be measured and at least one constant reference surface, which is located near to the said surface being measured, using at least two different wavelengths and two different angles. The light reflected or scattered from both the surface to be measured and the reference surface is directed to a detector, on which an image is formed of the surface to be measured and the reference surface. Because the properties of the reference surface have been standardized, with its aid it is possible to calibrate or otherwise analyse the image of the surface.

According to one point of view, the device according to the invention comprises
means for producing illuminating light, which means are arranged to aim the illuminating light on the surface being measured, at two different wavelengths and two different angles,
means for directing the light reflected or scattered from the surface to a detector, in order to create an image of the surface being measured,

which device further comprises
at least one reference surface, which can be located in the vicinity of the surface being measured, in such a way that the illuminating light is also directed to the reference surface and the light reflected or scattered from the reference surface can also be directed to the detector.

According to the above embodiment, the device comprises 1-3 separate reference surfaces, which comprise one or several of the following areas:
a white area of even colour or a white-black area for determining the white balance of the image formed on the detector,
an area comprising different tones for determining the colour balance of the image formed on the detector,
an area of differing roughness, topography, and/or glossiness for determining the roughness, topography, or degree of glossiness of the surface being measured.

According to one embodiment, the device comprises an opening or window, from which the illuminating light can be directed to the surface to be measured and the said at least one reference surface is located at the edge of the said opening or window. The reference surface is preferably located on essentially the same optical plane as the surface being measured, i.e. in practice on a thin base, which is set on the subject, in such a way that it delimits the subject. According to a preferred embodiment, there are three different types of reference area and they are located at different edges of the said opening or window.

According to one embodiment, the means for producing the illuminating light comprise LED lamps, which operate on at least two different wavelengths.

The means for directing the light reflected or scattered from the surface to the detector preferably comprise enlarging optics, with the aid of which an enlarged image of the surface to be measured and of the said at least one reference surface can be formed on the detector. In this way, a microscopic measuring device is obtained. According to an alternative embodiment, if the device is connected to a host device suitable for microscope imaging, it will be possible to use only the optics of the host device.

According to one embodiment, particularly if it is desired to measure the topography, roughness, or glossiness of a surface, the device is arranged to take images of the surface to be measured from different illumination angles.

According to one embodiment, the device is formed as a device module, which is can be operationally connected to a host device, such as a mobile telephone equipped with a camera, in which case the detector in the host device is utilized as the said detector. Further, the device can comprise means for receiving a triggering signal form the host device, and means for illuminating the surface to be measured in response to a triggering signal obtained from the host device.

Alternatively, according to an embodiment, the device can itself comprise the said detector and/or means for analysing an image obtained on the detector.

In the method according to the invention
the surface to be measured is illuminated at at least two different wavelengths and at two different angles,
the light reflected or scattered from the surface to be measured is directed to a detector, in order to create an image of the surface,
simultaneously with the illumination of the surface to be measured, at least one reference surface is illuminated, which is located in the vicinity of the surface to be measured, in which case the light reflected or scattered from the reference surface is also directed to the detector, in order to create an image of the reference surface, and
the image of the surface to be measured is analysed by utilizing the image of the reference surface.

The said reference surface can be a surface containing two different tones, and the image of the surface to be measured is calibrated with the aid of at least one image of the reference surface, in order to calibrate the colour tones of the surface to be measured.

The said reference surface can also be a surface with altered roughness, topography, and/or degree of glossiness, in which case images are made of the surface to be measured and the said reference surface from different illumination angles, and the roughness, topography, or glossiness of the surface to be measured are determined with the aid of the said at least one reference surface.

The term a surface with altered roughness, topography, and/or degree of glossiness refers to a surface, which has known roughness, topography, or glossiness properties, which can be utilized in the analysis stage, in such a way that also the corresponding property of the surface to be measured can be determined.

The analysis is preferably performed separately for each wavelength channel of the detector, particularly for the reliable calibration of the colours of the surface to be measured.

The method described above is performed by using a device like that described above, which is built as a module and connected to a host device, such as a mobile telephone, in which case the detector of the host device is utilized to create an image and/or the data-processing unit of the host device is utilized to analyse an image of the surface to be measured.

More specifically, the invention is characterized by what is stated in the characterizing portions of the independent Claims.

Considerable advantages are achieved with the aid of the invention. Because the device comprises both illumination at several wavelengths and angles, and a reference surface, it is possible to combine in a new manner the measurement of both imaging colour measurement and the measurement of the micro-structure of the surface. The invention also permits excellent precision and repeatability while using a simple device construction with low production costs.

The areas of application of the invention include portable colour-measuring devices, as well as glossiness and roughness-shape measuring devices. The invention also permits, for instance, the integration of precise colour and surface measurements as part of a portable camera phone.

In the following, embodiments and advantages of the invention are examined in greater detail with reference to the accompanying drawings.

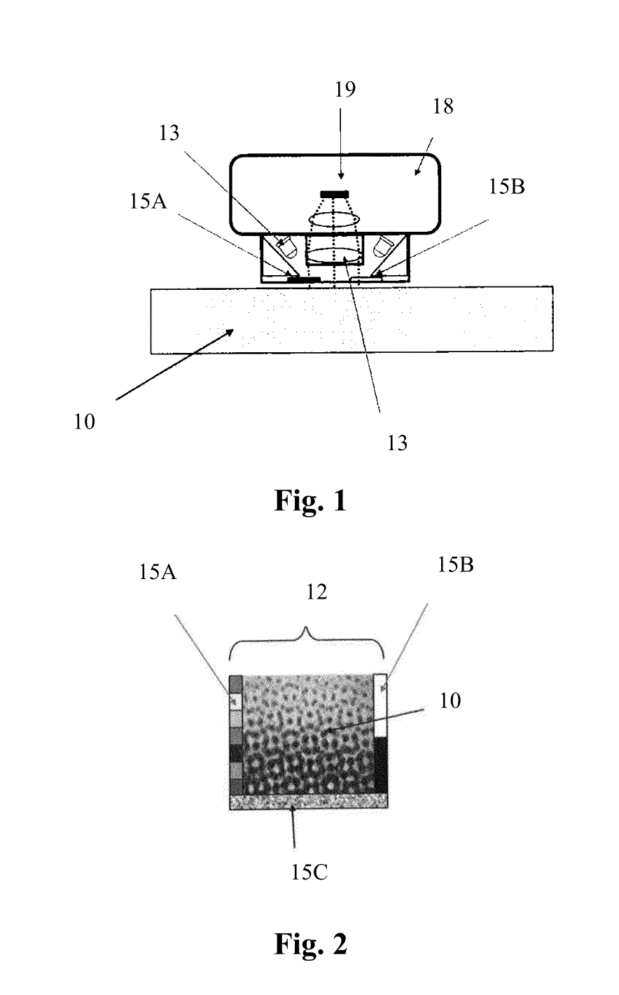

FIG. 1 shows the device construction according to the invention, according to one embodiment.

FIG. 2 shows a microscope image taken using the device construction according to FIG. 1. In the centre of the image area is an image of the surface to be measured. At the edges of the image area are images of reference surfaces set close to the surface to be measured.

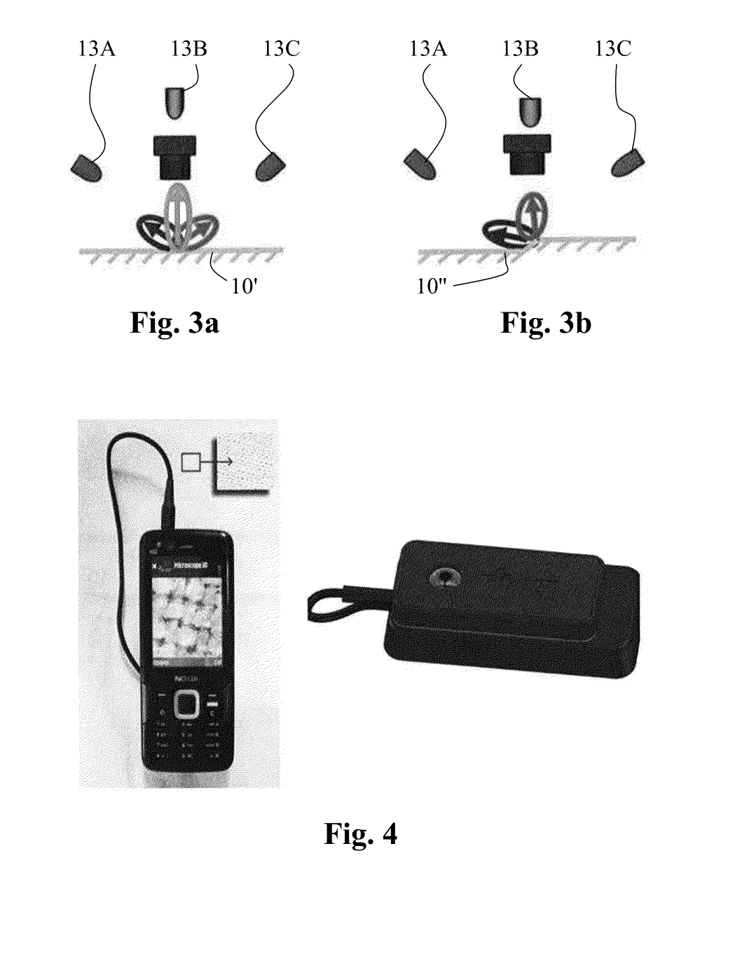

FIGS. 3a and 3b show the principle of the implementation of the measurement of the glossiness and topography of a surface using lights set at different geometries. Each illumination geometry produces a different image, depending on the shape and degree of glossiness of the surface. In FIG. 3b, a change in the shape of the surface will appear differently in an image illuminated from the left-hand direction than in an image illuminated from the right-hand direction.

FIG. 4 shows a module comprising illumination optics and reference areas, connected to a mobile telephone, which converts the mobile telephone into a precision measuring device, by means of which the colour, topography, and degree of glossiness of a surface can be determined. In addition, the device can be used to document the surface structure in 2D and 3D images.

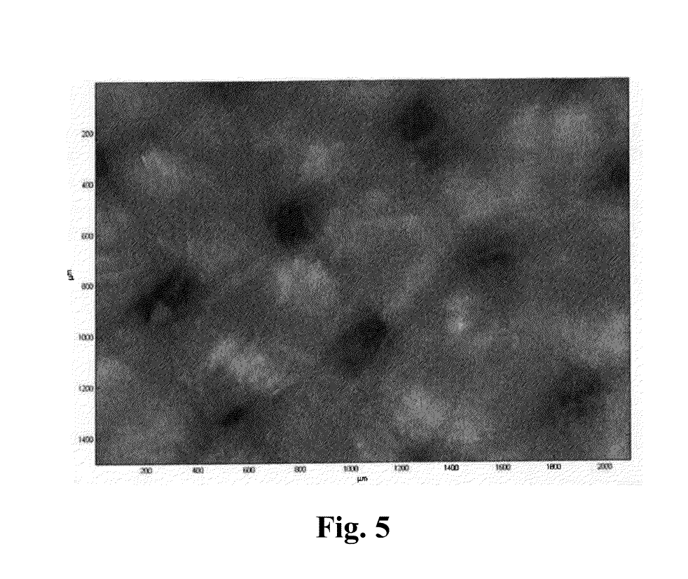

FIG. 5 shows a structural image of a textile, imaged using a microscope module connected to a mobile telephone.

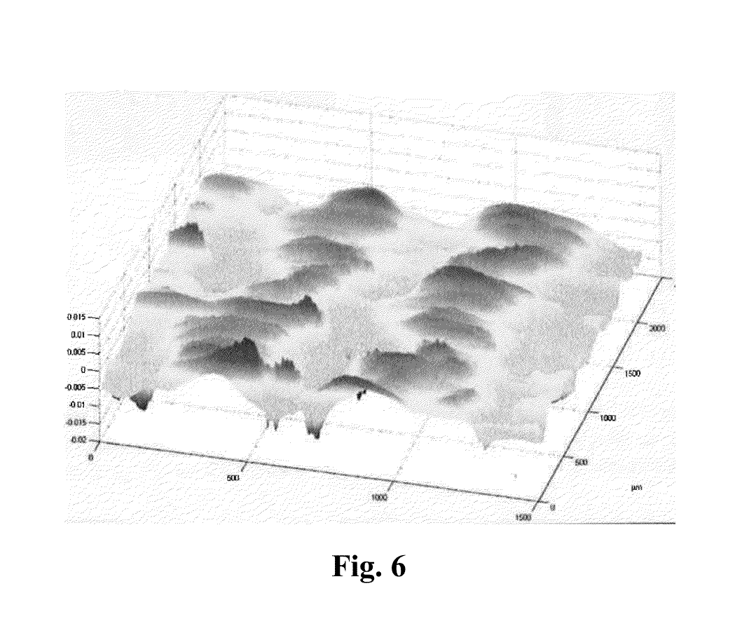

FIG. 6 shows a 3D image of the subject of FIG. 5 produced using a microscope module. With the aid of the 3D image, the quality of the evenness and weave of the surface, for example, can be documented.

The invention discloses a new type of method and device construction, by means of which the colour of a surface and also other properties of the surface can be measured accurately and repeatedly. The central new idea of the method is to combine a simultaneous reference measurement with the measurement, with the aid of which variations in the illumination source and the photo sensor can be calibrated. The areas of application of the invention include portable surface colour-measurement devices and glossiness and roughness-shape measuring devices. The invention permits, for instance, precise colour and surface measurement to be integrated as part of a portable camera phone. Based on the invention, new types of business-operation model combining mobile measurements and server services can be implemented.

When measuring the colour and other optical properties of a surface, the illumination source and the control of the properties of the photo sensor are central. Changes in the intensity or radiation spectrum of the illumination source, as well as in the sensitivity and wavelength response of the photo sensor directly affect the measurement result, if their effect is not corrected by calibration. The present invention solves this problem by including the illumination device/illumination devices and a reference surface permitting calibration in the same device unit. By means of such a construction, it is possible to measure not only the colour of a surface, but also the other properties of the surface, precisely and repeatedly. It is a novel key idea of the method to introduce to the measurement simultaneous reference measurement with aid of which variation of the properties of the light source and the photo sensor can be calibrated.

Measurement is implemented using a device to be set on top of the surface, which includes an illumination and imaging unit producing a microscope image of the surface, as well as a reference-surface structure ensuring the accuracy of the measurement. This can be an area of white even colour, or a white-black area in order to determine the while balance of the image formed on the detector, an area comprising different colour tones (differing from grey tones) in order to determine the colour balance of the image formed on the detector, and an area with altered roughness, topography, and/or glossiness, in order to determine the roughness, topography, or degree of glossiness of the surface to be measured.

With reference to FIGS. 1 and 2, the present device comprises, according to one embodiment, a photo sensor 19 (e.g., a CCD cell producing a colour image), imaging optics 13, illumination structures 13 implemented using LEDs, as well as a surface 10 to be measured and reference surfaces 15A, 15B, 15C located in the vicinity of the image area 12. These references surfaces are a permanent part of the device construction and are brought so close to the surface to be measured that both the surface to be measured and the reference surfaces can be seen (sufficiently precisely) in the image formed by the imaging optics, according to FIG. 2.

According to the figures, the illumination and imaging optics are implemented in such a way that the surface to be measured and the reference areas are illuminated in essentially the same geometry. Similarly, the imaging geometry is essentially the same for both the reference surface and the surface to be measured. Thus, the information received from the reference surfaces can be utilized directly in determining the properties of the surface to be measured.

As has become apparent above, the detector or all of the imaging optics need not form part of the same device construction as the illumination and the reference surfaces, but instead the device can form a separate module to be connected operationally to a host device 18. In that case, the device components belonging to the module are preferably cased to form an integrated unit, which further comprises means for receiving a command signal from the host device or for transmitting a command signal to the host device to set illumination and detection to be simultaneous. Such a practical solution is shown in FIG. 4.

There are preferably at least two wavelength channels available, but in order to create complete colour definition there are three or more, for example, a red, green, and blue channel (RGB), as will be explained in greater detail below.

In the same way, there are preferably two surface-illumination angles, which in practice often means using several separate illumination sources, such as LED lights. The illumination sources are preferably located symmetrically relative to the normal of the surface to be measured, which will simplify the interpretation of the images. The illumination sources can be located in a circle drawn around the normal of the surface to be measured, and, for example, 2-20 of them can be placed at equal intervals. The illumination sources are preferably sources with at least three different wavelength bands.

### Colour Measurement

With the aid of the device, it is possible to determine the colour of a surface by taking RGB colour images of the subject (in the examples shown in FIGS. 3a and 3b, the LED lights 13A, 13B, 13C each represent a single channel R/G/B) and by calibrating a precise tone with the aid of the known tones of the reference area at the edges of the image. In RGB imaging, the camera takes three separate images of the subject simultaneously, in each of which images a specific wavelength band (red, green, and blue bands) has been filtered out of the light.

As is known, the use of RGB imaging makes it possible to obtain sufficient colour differentiation for most application, if the properties of the illumination, wavelength bands, and geometries are controlled. Promising results have been obtained using RGB imaging in research projects, in which the colour-measurement accuracy of an RGB camera has corresponded to the performance of commercial colour meters.

In the present invention, the precision of the colour measurement based on RGB imaging is increased with the aid of calibration made from the same image. By means of the solution described, the following factors substantially affecting the precision of colour measurement can be compensated for:
the intensity of the illumination and its variations
the spectrum of the illumination
the intensity response of the camera in the RGB channels
the spectral variation of the RGB channels
variations in the camera's offset levels.

In most cameras, especially CMOS cameras integrated in mobile telephones, the camera electronics are implemented in such a way that the ratio and offset values of the images' RGB channels are balanced in connection with the taking of each image. This makes determining colour solely on the basis of an image very imprecise. A reference measurement made from each image will correct the variations caused by such factors. Known tones of the reference surface, as well as, for example, the black, white, and grey tones of the reference surface can be used for the correction.

The RGB camera used for colour imaging can also be replaced, for example, with a black-and-white camera and an adjustable narrow-band colour filter placed in front of it. The colour filter can be, for example, an electrically adjustable Fabry-Perot filter.

FIG. 5 shows a structural image of a textile, implemented with the aid of colour measurement.

FIG. 2 shows how the colours of the surface 10 to be measured are measured using an embodiment of the method according to the invention, in which the surface 10 to be measured is placed in an active window, which is framed by a reference area, in which three reference surfaces 15A, 15B, 15C are located. Of these reference surfaces, the reference surface 15A comprises different colour tones, in order to determine the colour balance formed on the detector. The second reference surface 15B comprises a black-white image, in order to determine the white balance of the image formed on the detector. The second reference surface 15B can be of even colour, such as even white, white-blank, or a darkening pattern moving from white to black, in order to determine the white balance of the image. The third reference surface 15C comprises a reference surface (15C) altered in roughness, topography, and/or glossiness, in order to determine the roughness, topography, or degree of glossiness of the surface (10) to be measured. As stated, according to the embodiment shown in FIG. 2, the image of the surface 10 is calibrated with the aid of the said reference surface 15A comprising different colour tones, in order to calibrate the colour tones of the surface 10 to be measured, in such a way that the reference surface 15A comprising different colour tones is continuously in the reference area.

According to the invention, the calibration of colour tones can also be performed in a separate calibration stage. According to one embodiment, before the measurement of the properties of the surface 10, an initial calibration stage is performed, in which a reference surface (not shown) located in the active window is used to determine the colour balance of the image formed on the detector. The reference surface located in the active window is preferably a changeable reference surface, which comprises at least one standard colour, in order to determine the colour balance of the image formed on the detector. Changeable reference surfaces are available commercially and with their aid a reference colour comprising the correct wavelength can be reliably created. Using commercial changeable colour samples, a huge range of different colours also becomes available for use. The reference surface preferably contains only a single colour. The reference surface located in the active window is essentially as large as the active window, so that distortions caused by lenses can be eliminated. Because the reference colour—preferably a single-colour reference colour—fills the entire active window, the values that are distorted due to lens error are filtered out of the measured wavelength values. A large reference colour will also reduce measurement noise. In a separate colour-calibration stage preceding measurement, a reference surface 15A comprising different colour tones can be placed in the active window, in order to determine the colour balance of the image formed on the detector. After the calibration stage, the reference surface is removed from the active window, in order to begin measuring the properties of the surface 10.

### Measurement of the Glossiness, Roughness, and Topography of a Surface

To measure the other properties of a surface, the device construction is implemented in such a way that the surface can be illuminated using not only the illumination used for the colour measurement, but also using lights producing several different illumination geometries. The illumination component consists of LEDs, or combinations of LEDs and illumination optics, placed in several different geometries, according to the principle shown in FIGS. 3a and 3b.

In order to measure surface properties, the device takes several images consecutively, in such a way that different illumination geometries are used in each image. Each illumination produces in the image a different response depending on the degree of glossiness and topography of the surface. The surface's properties are computed from the ratios of these images. For example, the shape and topography of the surface can be determined with the aid of photometric stereo measurement, by taking two images in such a way that there is an opposite direction of illumination of the surface in these images. The degree of glossiness of the surface can be determined, for example, by taking two images of the surface, in one of which the illumination is at a mirror angle to the imaging angle and, in the other, at an angle of, for example 45 degrees to the imaging angle, and by calculating the ratio between these images. The illuminations in different geometries are mutually of the same colour, so that the measurement of the surface properties will not depend on the colours of the surface. This principle is illustrated in FIGS. 3a and 3b. As can be seen, compared to the surface 10′ the uneven surface 10″ gives a different response, depending on the direction of illumination.

The device is preferably arranged to also use the reference surface for calibrating these measurement results. In this case, the reference surface can comprise, for example, different known micro-structure shape and degrees of glossiness of the surface.

FIG. 6 shows a topographical image of a textile, created using the above principle.

### Maintaining Calibration and Precision

The measuring device according to the invention is calibrated and the calibrated precision is maintained using the following procedure:

A. Measurement of a Known Calibration Sample

The device is used initially to image one or more known samples. In the centre of the image area of the device there is then a known surface and reference areas in the edge areas of the image. On the basis of this image data the device computes the colour parameters and the parameters of the other surface properties for the reference areas, i.e. in other words it calibrates the reference areas.

B. Calibration of Measurement With the Aid of the Reference Areas

When measuring, the device images simultaneously the surface to be measured and the reference areas. The device then uses the reference areas for the calibration of the measurement.

### Possibilities for Exploiting the Invention

With the aid of the invention, it is possible to implement, for example, measuring and documentation systems for the quality of surfaces, for the requirements of paint shops or the textile industry. With the aid of a cell phone, the measurement data can be sent to a server, where a database of materials, colours, and surface properties is maintained. With the aid of the server, extensive analyses can also be implemented. The information and analysis services of the entire database will also be available in the measuring situation (including classifications, database searches, and colour analyses).

Stated more generally, the solution disclosed can be used to implement electronic services, if the host device is a device equipped with a telecommunications link (or if the device itself is equipped with telecommunications connections), in such a way that
in the host device, an identifier in digital form (e.g., information on the surface to be measured, the measurement time, etc.) is attached to the information obtained from the surface to be measured,
the host device is used to transmit at least part of the information obtained from the surface to be measured and the said identifier to a remote server with the aid of the said telecommunications link,
an acknowledgement of the reception of the information obtained from the surface to be measured and the identifier is received by the host device from the said remote server, over the said telecommunications link.

Further, the information on the measured surface on the remote server can be compared with information sent previously to the remote server and the result of the said comparison can be received by the host device from the remote server.

1. Device for determining the properties of a surface, said device comprising;
a means for producing illuminating light, said means being arranged to aim the illuminating light at a surface to be measured, said means having at least two different wavelengths aimed at the surface at at least two different angles,
a means for directing light reflected or scattered from the surface to a detector in order to create an image of the surface to be measured, and
at least one reference surface which can be placed in the vicinity of the surface to be measured in such a way that the illuminating light is also directed to the reference surface and the light reflected or scattered from the reference surface can be directed to the detector.

2. A device according to claim 1, wherein the device comprises 1-3 separate reference surfaces, and wherein each separate reference surface comprises one or more of the following areas:
a white area of even colour, or a white-black area, for determining the white balance of the image formed on the detector,
an area comprising different colour tones, in order to determine the colour balance of the image formed on the detector,
an area of altered roughness, topography, and/or glossiness, in other to determine the roughness, topography, or degree of glossiness of the surface to be measured.

3. A device according to claim 1, wherein the device comprises an opening or window, and wherein the illuminating light directed to the surface to be measured and the at least one reference surface is located at

4. A device according to claim 3, wherein the reference areas are of three different types and they are located at different edges of the said opening or window.

5. A Device according to claim 1, wherein the means for producing an illuminating light comprises LED lamps which operate on at least two different wavelengths.

6. A Device according to claim 1, wherein the means for directing the light reflected or scattered from the surface to the detector comprise enlarging optics, with the aid of which an enlarged image of the surface to be measured and of the said at least one reference surface can be formed on the detector.

7. A Device according to claim 1, wherein the device is arranged to take an image of the surface to be measured at different illumination angles.

8. A Device according to claim 1, wherein the device is formed into a device module which can be operationally connected to a host device, in which case the detector of the host device is utilized as the said detector.

9. A Device according to claim 8, wherein the device further comprises a means for receiving a triggering signal from the host device and a means for illuminating the surface to be measured in response to a triggering signal sent from the host device.

10. A Device according to claim 1, wherein the device further comprises a detector and means for analysing the image received on the detector.

11. A method for measuring the properties of a surface, said method comprising the steps of
illuminating a surface to be measured using at least two different wavelengths at at least two different angles,
directing light reflected or scattered from the surface to be measured to a detector in order to create an image of the surface
simultaneously, with the illumination of the surface to be measured,
illuminating at least one reference surface, which has known properties and which is located in the vicinity of the surface to be measured, wherein the light reflected or scattered from the reference surface is also directed to the detector₇ in order to create an image of the reference surface, and
the image of the surface 044 to be measured is analysed by exploiting the image of the reference surface.

12. A method according to claim 11, wherein an image area is illuminated, said image area comprising:
an active window, into which the surface to be measured is fitted, and
a reference area, which is in the vicinity of the active window, and which comprises at least one reference surface.

13. A method according to claim 12, wherein the reference area frames the active window.

14. A method according to claim 12, further comprising the step of determining the white balance of the image formed on the detector by comparing to an even colour reference surface of the reference area.

15. (canceled)

16. A method according to claim 12, further comprising determining the roughness, topography or degree of glossiness of the surface to be measured by comparing to a reference surface of the reference areas having altered roughness, topography and/or glossiness.

17. A method according to claim 12, further comprising determining the colour balance of the image formed on the detector by comparing to a reference surface of the reference area having different colour tones.

18. A method according to claim 17, further comprising calibrating the image of the surface to be measured with the aid of a reference surface having different colour tones, in order to calibrate the colour tones of the surface to be measured, in such a way that the reference surface comprising different colour tones is continuously in the reference area.

19. A method according to claim 12, further comprising, before the measurement of the properties of the surface, placing a reference surface in the active window to calibrate the image surface in order to determine the colour balance of the image formed on the detector.

20. A method according to claim 19, further comprising determining the colour balance of the image formed on the detector by placing a changeable reference surface which has at least one standard colour in the active window.

21. (canceled)

22. (canceled)

23. (canceled)

24. A method according to claim 19, further comprising, after the calibration stage, removing the reference surface from the active window in order to initiate measurement of properties of the surface.

25. A method according to claim 11, further comprising
taking images of the surface to be measured and the reference surface at different angles of illumination,
wherein the roughness, topography, or glossiness of the surface to be measured are determined with the aid of an image of at least one reference surface.

26. A method according to claim 11, further comprising separately analysing each wavelength channel of the detector.

27. (canceled)

28. A method according to claim 11, wherein
a host device is equipped with a telecommunications link,
an identifier in a digital form is attached in the host device to the information obtained from the surface to be measured,
at least part of the information obtained from the surface to be measured, as well as the said identifier, are sent using the host device to a remote server, with the aid of a telecommunications link, and
an acknowledgement of the reception of the information obtained from the surface to be measured and the identifier is received on the host device from the said remote server, over the said telecommunications link.

29. A method according to claim 28, wherein
on the remote server, the information on the surface to be measured is compared with information previously sent to the remote server, and
the result of the said comparison is received on the host device from the remote server.
